(19) United States
(12) Patent Application Publication
(10) Pub. No.: US 2008/0262942 A1
(43) Pub. Date: Oct. 23, 2008

(54) DIGITAL EXCHANGE SYSTEM AND METHOD

(76) Inventors: William Paul Bissett, Tampa, FL (US); David D. R. Kohler, Portland, OR (US)

Correspondence Address: HOLLAND & KNIGHT LLP, 10 ST. JAMES AVENUE, 11th Floor, BOSTON, MA, 02116-3889, US

(21) Appl. No.: 12/108,224

(22) Filed: Apr. 23, 2008

Related U.S. Application Data
(60) Provisional application No. 60/913,527, filed on Apr. 23, 2007.

(51) Int. Cl. G06Q 30/00; G06Q 99/00; G06Q 90/00

(52) U.S. Cl. 705/26; 705/500; 705/1

(57) ABSTRACT

A method and computer program product for associating a value with a first digital content by a first party, thus defining a first value. The first digital content is provided to a second party. A second digital content is received from the second party that is based, at least in part, on the first digital content. The second digital content provides a first enhancement to the first digital content. A value is associated with the first enhancement of the second digital content, thus defining a second value.

### RELATED APPLICATIONS

This disclosure claims the benefit of U.S. Provisional Patent Application No. 60/913,527, which is entitled SYSTEM FOR MARKETING DIGITAL PRODUCTS and was filed on 23 Apr. 2007, the entire disclosure of which is incorporated by reference.

This disclosure claims priority to U.S. patent application Ser. No. ______, which is entitled DATA CONVERSION SYSTEM AND METHOD and was filed on 23 Apr. 2008, the entire disclosure of which is incorporated by reference.

This disclosure claims priority to U.S. patent application Ser. No. ______, which is entitled DIGITAL CONTENT MARKETING SYSTEM AND METHOD and was filed on 23 Apr. 2008, the entire disclosure of which is incorporated by reference.

### TECHNICAL FIELD

This disclosure relates to digital exchange systems and, more particularly, to digital exchange systems that encourage re-use of digital content.

### BACKGROUND

Digital content is available from multiple producers. A large portion of this digital content is originally produced from scratch without much re-use of existing digital content. When digital content is re-used for the production of new digital content, a producer often draws from his own inventory of existing digital content, and produces the additional digital content necessary to generate the new digital content product. When a producer wishes to re-use digital content from another producer e.g., as the starting point for new digital content or as an enhancement to a new digital content product, typically a lengthy, uncertain, and possibly expensive set of negotiations may take place to license the existing digital content so that it may be incorporated into the new digital content product.

### SUMMARY OF THE DISCLOSURE

In a first implementation, a method of marketing digital content includes associating a value with a first digital content by a first party, thus defining a first value. The first digital content is provided to a second party. A second digital content is received from the second party that is based, at least in part, on the first digital content. The second digital content provides a first enhancement to the first digital content. A value is associated with the first enhancement of the second digital content, thus defining a second value.

One or more of the following features may be included. The second digital content may be offered for a first final value that is at least the sum of the first value and the second value. The first party and the second party may be the same party. The second digital content may be sold/licensed to a purchaser. The first value may be provided to the first party. The second value may be provided to the second party. The second digital content may be provided to the purchaser.

A third digital content may be received from the purchaser that is based, at least in part, on the second digital content. The third digital content may provide a second enhancement to the second digital content. A value may be associated with the second enhancement of the third digital content, thus defining a third value. The third digital content may be offered for a second final value that is at least the sum of the first value, the second value, and the third value.

In another implementation, a computer program product resides on a computer readable medium having a plurality of instructions stored on it. When executed by a processor, the instructions cause the processor to perform operations including associating a value with a first digital content by a first party, thus defining a first value. The first digital content is provided to a second party. A second digital content is received from the second party that is based, at least in part, on the first digital content. The second digital content provides a first enhancement to the first digital content. A value is associated with the first enhancement of the second digital content, thus defining a second value.

One or more of the following features may be included. The second digital content may be offered for a first final value that is at least the sum of the first value and the second value. The first party and the second party may be the same party. The second digital content may be sold/licensed to a purchaser. The first value may be provided to the first party. The second value may be provided to the second party. The second digital content may be provided to the purchaser.

A third digital content may be received from the purchaser that is based, at least in part, on the second digital content. The third digital content may provide a second enhancement to the second digital content. A value may be associated with the second enhancement of the third digital content, thus defining a third value. The third digital content may be offered for a second final value that is at least the sum of the first value, the second value, and the third value.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a digital exchange process coupled to a distributed computing network; and

FIG. 2 is a flowchart of a process executed by the digital exchange process of FIG. 1.

Like reference symbols in the various drawings indicate like elements.

### DETAILED DESCRIPTION OF THE DISCLOSURE

### System Overview:

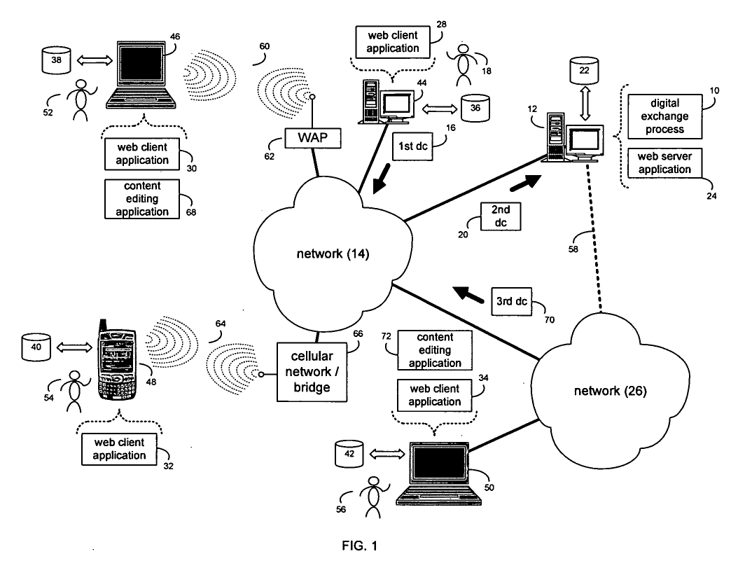

Referring to FIG. 1, there is shown digital exchange process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, digital exchange process 10 may provide a first digital content 16 (e.g., a map) that may be authored by a first party (e.g., user 18). A value (e.g., $100) may be associated with first digital content 16, thus defining a first value at which first digital content 16 is offered. As used in this disclosure, “offered” is intended to include e.g., offering first digital content 16 “for sale” and/or offering first digital content 16 “for license”. A second digital content (e.g., second digital content 20) may be received from a second party that is based, at least in part, on first digital content 16. Second digital content 20 may provide a first enhancement (e.g., a first overlay) to first digital content 16. A value ($50) may be associated with the first enhancement of second digital content 20, thus defining a second value.

The instruction sets and subroutines of digital exchange process 10, which may be stored on storage device 22 coupled to server computer 12, may be executed by one or more processors (not shown) and one or more memory architectures (not shown) incorporated into server computer 12. Storage device 22 may include but is not limited to: a hard disk drive; a tape drive; an optical drive; a RAID array; a random access memory (RAM); and a read-only memory (ROM).

Server computer 12 may execute web server application 24, examples of which may include but are not limited to: Microsoft IIS™, Novell Webserver™, or Apache Webserver™, that allows for HTTP (i.e., HyperText Transfer Protocol) access to server computer 12 via network 14. The instruction sets and subroutines of web server application 24, which may be stored on storage device 22 coupled to server computer 12, may be executed by one or more processors (not shown) and one or more memory architectures (not shown) incorporated into server computer 12.

Network 14 may be connected to one or more secondary networks (e.g., network 26), examples of which may include but are not limited to: a local area network; a wide area network; or an intranet, for example. Digital exchange process 10 may be a stand alone application that interfaces with web server application 24 or an applet/application that is executed within web server application 24.

The instruction sets and subroutines of web client applications 28, 30, 32, 34 which may be stored on storage devices 36, 38, 40, 42 (respectively) coupled to client electronic devices 44, 46, 48, 50 (respectively), may be executed by one or more processors (not shown) and one or more memory architectures (not shown) incorporated into client electronic devices 44, 46, 48, 50 (respectively). Storage devices 36, 38, 40, 42 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of web client applications 28, 30, 32, 34 may include Microsoft Internet Explorer™, Apple Safari™, and Mozilla FireFox™.

Examples of computing devices 44, 46, 48, 50 may include, but are not limited to, personal computer 44, laptop computer 46, personal digital assistant 48, notebook computer 50, a data-enabled, cellular telephone (not shown), and a dedicated network device (not shown), for example. Using web client applications 28, 30, 32, 34, users 18, 52, 54, 56 may allow access to one or more applications resident on and served by e.g., server computer 12 and/or web server application 24.

Users 18, 52, 54, 56 may access web server application 24 directly through the device on which the web client application (e.g., web client applications 28, 30, 32, 34) is executed, namely client electronic devices 44, 46, 48, 50, for example. Users 18, 52, 54, 56 may access web server application 24 directly through network 14 or through secondary network 26. Further, server computer 12 (i.e., the computer that executes web server application 24) may be connected to network 14 through secondary network 26, as illustrated with phantom link line 58.

The various client electronic devices may be directly or indirectly coupled to network 14 (or network 26). For example, personal computer 44 is shown directly coupled to network 14 via a hardwired network connection. Further, notebook computer 50 is shown directly coupled to network 26 via a hardwired network connection. Laptop computer 46 is shown wirelessly coupled to network 14 via wireless communication channel 60 established between laptop computer 46 and wireless access point (i.e., WAP) 62, which is shown directly coupled to network 14. WAP 62 may be, for example, an IEEE 802.11a, 802.11b, 802.11g, Wi-Fi, and/or Bluetooth device that is capable of establishing wireless communication channel 60 between laptop computer 46 and WAP 62. Personal digital assistant 48 is shown wirelessly coupled to network 14 via wireless communication channel 64 established between personal digital assistant 48 and cellular network/bridge 66, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 44, 46, 48, 50 may each execute an operating system, examples of which may include but are not limited to Microsoft Windows™, Microsoft Windows CE™, Redhat Linux™, or a custom operating system.

### System Operation:

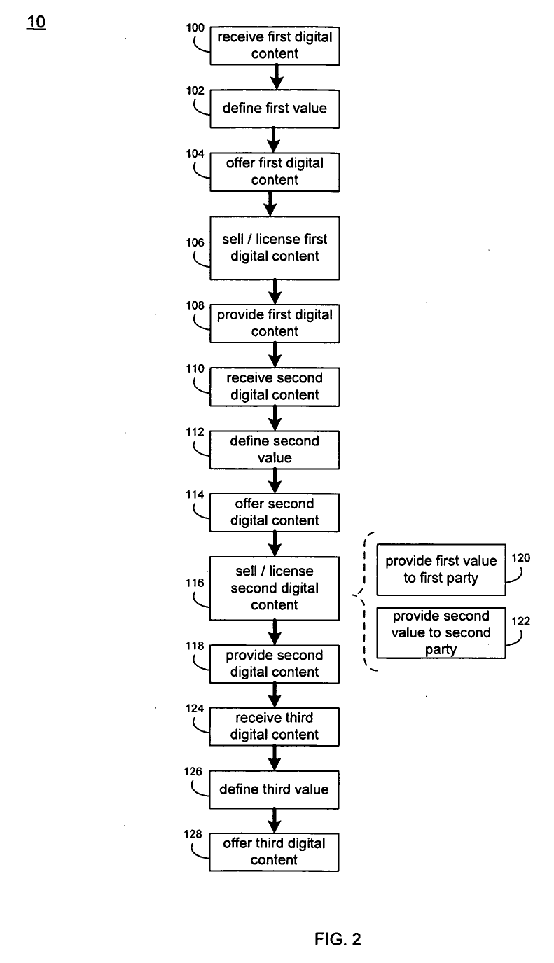

Referring also to FIG. 2 and as discussed above, assume that user 18 is a mapmaker and user 18 generates a map of Tampa Bay, Fla. (e.g. first digital content 16). Assume that user 18 would like to offer first digital content 16 to third parties. As discussed above, this offer may be in the form of e.g. an outright sale, an exclusive license, or a nonexclusive license. Accordingly, user 18 may upload first digital content 16 (from personal computer 44 to server computer 12 via network 14) to digital exchange process 10. Once received 100, digital exchange process 10 may allow user 18 to define 102 a value that may be associated with first digital content 16. As discussed above, assume for illustrative purposes that user 18 defines 102 (via web client application 28) a value of $100 for a nonexclusive license to first digital content 16. Digital exchange process 10 (via web server application 24) may e.g. serve a webpage that offers 104 a nonexclusive license to first digital content 16 for $100.

Further assume for illustrative purposes that a second party (e.g., user 52) is a producer of digital content who browses (via web client application 30) the offerings of digital exchange process 10. Further, assume that user 52 desires to use first digital content 16 as a starting point for making second digital content 20. Continuing with the above stated example, assume for illustrative purposes that user 52 has population density data that user 52 would like to display as an overlay on top of first digital content 16 (i.e. the map of Tampa Bay Fla.). Assuming that user 52 finds the $100 nonexclusive licensing fee to be reasonable, user 52 may effectuate payment of the $100 fee to digital exchange process 10 and digital exchange process 10 may sell/license 106 first digital content 16 to user 52. Once payment is effectuated, digital exchange process 10 may provide 108 first digital content 16 to user 52 (via e.g. network 14 and wireless communication channel 60). For example, digital exchange process 10 may allow user 52 to download a copy of first digital content 16.

At this point in time (or at sometime in the future), digital exchange process 10 may provide remuneration to user 18 with respect to the sale/license of first digital content 16 to user 52. As discussed above, user 18 defined 102 a non-exclusive license to first digital content 16 to have a value of $100. Accordingly, digital exchange process 10 may provide all or a portion of that $100 to user 18. For example, assuming that digital exchange process 10 charges all users with a 10% processing fee, digital exchange process 10 may provide user 18 with remuneration in the amount of $90.

Assume that upon receiving first digital content 16 from digital exchange process 10, user 52 modifies first digital content 16 (using e.g., content editing application 68) to generate second digital content 20. An example of content editing application 68 may include but is not limited to Adobe Photoshop™. The instruction sets and subroutines of content editing application 68, which may be stored on storage device 38 coupled to laptop computer 46, may be executed by one or more processors (not shown) and one or more memory architectures (not shown) incorporated into laptop computer 46. Assume, as discussed above, that user 52 modifies first digital content 16 to include the above-described population density data overlay.

Assume for illustrative purposes that, upon modifying first digital content 16 to generate second digital content 20, user 52 would like to offer second digital content 20 to third parties. As with first digital content 16, the offer of second digital content 20 may be in the form of e.g. an outright sale, an exclusive license, or a nonexclusive license. Accordingly, user 52 may upload second digital content 20 (from laptop computer 46 to server computer 12 via wireless communication channel 60 and network 14) to digital exchange process 10.

While related to first digital content 16, second digital content 20 provides a first enhancement (e.g., the above-described population density data overlay) to first digital content 16. Once second digital content 20 is received 110 from user 52, digital exchange process 10 may allow user 52 to define 112 a second value that is representative of the value of the first enhancement (e.g., the above-described population density data overlay) included within second digital content 20. As discussed above, assume for illustrative purposes that user 52 defines 112 (via web client application 30) a value of $50 for a nonexclusive license to the first enhancement (e.g., the above-described population density data overlay) included within second digital content 20. Accordingly, digital exchange process 10 (via web server application 24) may e.g. serve a webpage that offers 114 a nonexclusive license to second digital content 20 for $150 (i.e., the sum of the $100 nonexclusive licensing fee for first digital content 16 and the $50 nonexclusive licensing fee for the above-described population density data overlay).

Further assume for illustrative purposes that a third party (e.g., user 56) is also a producer of digital content who browses (via web client application 34) the offerings of digital exchange process 10. Further, assume that user 56 desires to use second digital content 20 as a starting point for making third digital content 70. Continuing with the above stated example, assume for illustrative purposes that user 56 has income data that user 56 would like to display as an overlay on top of second digital content 20 (i.e. the map of Tampa Bay, Fla. that includes the population density data overlay). Assuming that user 56 finds the $150 nonexclusive licensing fee to be reasonable, user 56 may effectuate payment of the $150 fee to digital exchange process 10 and digital exchange process 10 may sell/license 116 second digital content 20 to user 56. Once payment is effectuated, digital exchange process 10 may provide 118 second digital content 20 to user 56 (via e.g. network 14 and network 26). For example, digital exchange process 10 may allow user 56 to download a copy of second digital content 20.

At this point in time (or at sometime in the future), digital exchange process 10 may provide remuneration to users 18, 52 with respect to the sale/license of second digital content 20 to user 56. As discussed above, user 18 defined 102 a non-exclusive license to first digital content 16 (included within second digital content 20) to have a value of $100. Further and as discussed above, user 52 defined 112 a non-exclusive license to the first enhancement (e.g., the above-described population density data overlay) included within second digital content 20 to have a value of $50. Accordingly, digital exchange process 10 may provide 120, 122 all or a portion of that $100 to user 18 and all or a portion of that $50 to user 52. For example, assuming that digital exchange process 10 charges all users with a 10% processing fee, digital exchange process 10 may provide 120 user 18 with remuneration in the amount of $90 and may provide 122 user 52 with remuneration in the amount of $45.

Assume that upon receiving second digital content 20 from digital exchange process 10, user 56 modifies second digital content 20 (using e.g., content editing application 72) to generate the third digital content 70. Again, an example of content editing application 72 may include but is not limited to Adobe Photoshop™. The instruction sets and subroutines of content editing application 72, which may be stored on storage device 42 coupled to notebook computer 50, may be executed by one or more processors (not shown) and one or more memory architectures (not shown) incorporated into notebook computer 50. Assume, as discussed above, that user 56 modifies second digital content 20 to include the above-described income data overlay.

Assume for illustrative purposes that, upon modifying second digital content 20 to generate the third digital content 70, user 56 would like to offer third digital content 70 to third parties. As with first digital content 16 and second digital content 20, the offer of third digital content 70 may be in the form of e.g. an outright sale, an exclusive license, or a nonexclusive license. Accordingly, user 56 may upload third digital content 70 (from notebook computer 50 to server computer 12 via network 26 and network 14) to digital exchange process 10.

While related to second digital content 20, third digital content 70 provides a second enhancement (e.g., the above-described income data overlay) to second digital content 20 (which included a first enhancement (i.e., the above-described population density data) to first digital data 16). Once third digital content 70 is received 124 from user 56, digital exchange process 10 may allow user 56 to define 126 a third value that is representative of the value of the second enhancement (e.g., the above-described income data overlay) included within third digital content 70. As discussed above, assume for illustrative purposes that user 56 defines 126 (via web client application 34) a value of $75 for a nonexclusive license to the second enhancement (e.g., the above-described income data overlay) included within third digital content 70. Accordingly, digital exchange process 10 (via web server application 24) may e.g. serve a webpage that offers 128 a nonexclusive license to third digital content 70 for $225 (i.e., the sum of the $100 nonexclusive licensing fee for the first digital content 16, the $50 nonexclusive licensing fee for the above-described population density data overlay, and the $75 nonexclusive licensing fee for the above-described income data overlay).

While user 18 and user 52 are described above as being separate individuals, this is for illustrative purposes only and is not intended to be a limitation of this disclosure. For example, a single individual may offer for license two different versions of a map of Tampa Bay, Fla.; one which includes population density data (for a licensing fee of $150) and one which does not include population density data (for a licensing fee of $100).

While digital exchange process 10 is described above as offering 104 first digital content 16, which is modified by user 52 to generate second digital content 20, which is offered 114 to and modified by user 56 to generate third digital content 70, this is for illustrative purposes only and is not intended to be a limitation of this disclosure. For example, this iterative modification process may be repeated indefinitely and/or as long as market forces dictate.

While first digital content 16 is described above as being map-based data and second/third digital content 20, 70 are described above as being map overlay data, this is for illustrative purposes only and is not intended to be a limitation of this disclosure. For example, first digital content 16 may be a piece of software, and second/third digital content 20, 70 may be complementary software objects operable within first digital content 16. Accordingly, digital content, as used in this disclosure, is intended to include any and all digitized content, examples of which may include but are not limited to: digital audio, digital video, graphical files, document files, and software objects and applications.

A number of implementations have been described. Nevertheless, it will be understood that various modifications may be made. Accordingly, other implementations are within the scope of the following claims.

What is claimed is:

1. A method of marketing digital content comprising:
associating a value with a first digital content by a first party, thus defining a first value;
providing the first digital content to a second party;
receiving from the second party, a second digital content, based, at least in part, on the first digital content, wherein the second digital content provides a first enhancement to the first digital content; and
associating a value with the first enhancement of the second digital content, thus defining a second value.

2. The method of claim 1 further comprising:
offering the second digital content for a first final value that is at least the sum of the first value and the second value.

3. The method of claim 2 wherein the first party and the second party are the same party.

4. The method of claim 2 further comprising:
selling/licensing the second digital content to a purchaser.

5. The method of claim 4 further comprising:
providing the first value to the first party.

6. The method of claim 4 further comprising:
providing the second value to the second party.

7. The method of claim 4 further comprising:
providing the second digital content to the purchaser.

8. The method of claim 7 further comprising:
receiving from the purchaser a third digital content, based, at least in part, on the second digital content, wherein the third digital content provides a second enhancement to the second digital content.

9. The method of claim 8 further comprising:
associating a value with the second enhancement of the third digital content, thus defining a third value.

10. The method of claim 9 further comprising:
offering the third digital content for a second final value that is at least the sum of the first value, the second value, and the third value.

11. A computer program product residing on a computer readable medium having a plurality of instructions stored thereon which, when executed by a processor, cause the processor to perform operations comprising:
associating a value with a first digital content by a first party, thus defining a first value;
providing the first digital content to a second party;
receiving from the second party, a second digital content, based, at least in part, on the first digital content, wherein the second digital content provides a first enhancement to the first digital content; and
associating a value with the first enhancement of the second digital content, thus defining a second value.

12. The computer program product of claim 11 further comprising instructions for:
offering the second digital content for a first final value that is at least the sum of the first value and the second value.

13. The computer program product of claim 12 wherein the first party and the second party are the same party.

14. The computer program product of claim 12 further comprising instructions for:
selling/licensing the second digital content to a purchaser.

15. The computer program product of claim 14 further comprising instructions for:
providing the first value to the first party.

16. The computer program product of claim 14 further comprising instructions for:
providing the second value to the second party.

17. The computer program product of claim 14 further comprising instructions for:
providing the second digital content to the purchaser.

18. The computer program product of claim 17 further comprising instructions for:
receiving from the purchaser a third digital content, based, at least in part, on the second digital content, wherein the third digital content provides a second enhancement to the second digital content.

19. The computer program product of claim 18 further comprising instructions for:
associating a value with the second enhancement of the third digital content, thus defining a third value.

20. The computer program product of claim 19 further comprising instructions for:
offering the third digital content for a second final value that is at least the sum of the first value, the second value, and the third value.
